(19) United States
(12) Patent Application Publication
(10) Pub. No.: US 2002/0170000 A1
(43) Pub. Date: Nov. 14, 2002

(54) Test and on-board programming station

(76) Inventors: Emanuel Gorodetsky, Afula (IL); Eugeny Knupfer, Holon (IL)

Correspondence Address: FOGG SLIFER & POLGLAZE, P.A., P.O. BOX 581009, MINNEAPOLIS, MN, 55458-1009, US

(21) Appl. No.: 09/853,072

(22) Filed: May 9, 2001

(51) Int. Cl. H04L 1/22

(52) U.S. Cl. 714/30

(57) ABSTRACT

A production system for electronic circuits is provided. The system includes a computer having an associated storage medium and an interface unit, coupled to the computer that provides at least one port that is adapted to be coupled to the electronic circuit. The system further includes an editable object database, stored on the storage medium. The object database includes information on system parameters selectively used by the computer and the interface unit to implement a plurality of production procedures for the electronic circuit.

### TECHNICAL FIELD

The present invention relates generally to the field of electronics and, in particular, to production testing and on-board programming of electronic circuit boards and systems containing electronic circuit boards.

### BACKGROUND

As electronic circuit boards become more densely populated and contain more highly integrated components problems accompanying testing and programming of the circuit boards and the components thereon become more complex. Physically accessing connections, components and/or test points of components becomes difficult. At the component level, as circuit functionality becomes increasingly integrated in silicon, the capability of isolating and physically accessing particular elements of a given component become even more problematic since test nodes must be accessed at the component site and components may be mounted on both sides of the board.

With the trend towards the ever more densely populated integrated circuit boards and more highly integrated components, the need for validation of design and verification of functionality becomes increasingly important. To ensure that a particular product performs to specification, it is generally necessary to inject faults or errors into the system to simulate a potential field problem and determine if system diagnostics detect the problem and respond properly by, for example, switching-in redundant hardware to take over the functionality of the failed board or component.

IEEE/ANSI standard 1149.1-1990, also known as Joint Test Action Group (JTAG) and Boundary Scan, is a standard for testing integrated circuits as well as circuit boards. Boundary Scan requires that certain registers and dedicated pins be placed on a chip so that software can be used to implement test procedures. Dedicated pins provided on chips with a Boundary Scan test capability communicate with a Test Access Port (TAP) that gives access to logic that executes Boundary Scan and other test procedures.

The building of devices (whether components or board level systems) to the JTAG specification requires that they have the ability to test themselves through built-in self-test by allowing access to nodes and circuits that are otherwise physically inaccessible. This capacity is based upon the test access port (TAP) state machine that allows control and access to a “Boundary Scan” architecture. To implement the Boundary Scan architecture the component or board must include Boundary Scan cells that are implemented between each component pin or board connector and the internal logic circuitry. The Boundary Scan cells are also connected together forming a shift register path around the periphery of the circuit, giving rise to the term “Boundary Scan.”

Currently, the ability to test circuit boards or systems in production is cumbersome. Existing hardware, software, and technology is designed for specific aspects of board development. In order to evaluate a designed board during the production phase a separate test set-up is required at numerous stages. Each set-up requires hardware and software for the specific application and requires reprogramming for use with other board versions in the same system or other firmware versions of the same board. In addition, when a single manufacturer produces one or more systems of boards, different hardware and software configurations are required for the numerous production stages of each system. Alternately, using the same equipment for more than one system requires reprogramming the current test equipment for each production line and each hardware and firmware version of boards. The cost and complexity of the various test parameters is too burdensome for most manufacturers.

Current testing software for circuit boards is not compatible with other manufacturers hardware or software. Most of the software development and debugging tools can only be implemented with the manufacturer's test software/hardware platform. This lack of compatiblility with other test systems or software platforms provides additional limitations for the board manufacturer, as they do not have the ability to shop for a testing or programming system that best fits their needs in manufacturing.

For the reasons stated above, and for other reasons stated below which will become apparent to those skilled in the art upon reading and understanding the present specification, there is a need in the art for improvements in testing electronic circuit boards and systems that contain electronic circuit boards in particular during the production process.

### SUMMARY

The above mentioned problems with testing of electronics mounted on circuit boards during production and other problems are addressed by embodiments of the present invention and will be understood by reading and studying the following specification.

In one embodiment, a production system for electronic circuits is provided. The system comprises a computer having an associated storage medium, an interface unit, coupled to the computer, and providing at least one port that is adapted to be coupled to the electronic circuit. The system further includes an editable object database, stored on the storage medium, the object database including information on system parameters selectively used by the computer and the interface unit to implement a plurality of production procedures for the electronic circuit.

In one embodiment, a method for configuring production procedures for an electronic circuit is provided. The method includes providing a selection mechanism to identify the type of the electronic circuit and retrieving a plurality of module types for the selected electronic circuit. The method further includes providing a selection mechanism to identify the module type, retrieving additional selection options for the electronic circuit based on the module type, and presenting selection mechanisms in a hierarchical manner for the additional selection options.

### BRIEF DESCRIPTION OF THE DRAWINGS

FIG. 1 is an illustration of one embodiment of a testing system utilizing production procedures software according to the teachings of this invention.

FIG. 2 is an illustration of one embodiment of a database editor screen according to the teachings of this invention.

FIG. 3 is an illustration of one embodiment of a product selection screen according to the teachings of this invention.

FIG. 4 is an illustration of one embodiment of a board selection screen according to the teachings of this invention.

FIG. 5 is an illustration of one embodiment of a board version selection screen according to the teachings of this invention.

FIG. 6 is an illustration of one embodiment of a firmware version selection screen according to the teachings of this invention.

FIG. 7 is an illustration of one embodiment of a procedures selection screen according to the teachings of this invention.

FIG. 8 is an illustration of one embodiment of a graphical user interface according to the teachings of this invention.

FIG. 9 is an illustration of one embodiment of a fault locator screen according to the teachings of this invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, it is appreciated that throughout the present specification, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

Once a board has been designed and debugged it is ready for production. Embodiments of the present invention provide for sequential execution of volume production procedures using a universal user-friendly graphical user interface. Embodiments of the current invention provide a computerized PC-based system that is intended for implementation in the production process of electronic boards. Embodiments of the system are platform-independent and can be used with any software platforms based on Scan Function C or C++ library or their equivalents.

Embodiments of the present invention provide structural testing for implementation in a production setting and aid in identifying possible faults after assembly and for on-board programming for one or a group of electronic boards. Embodiments of the present invention find implementation in one or more of the following production states: board structural Boundary Scan test; structural fault location and diagnostics; complex programmable logic device (CPLD), flash, and field programmable gate array (FPGA) on-board programming; and inventory management programming. Embodiments of the present invention provide a production procedures program that integrates the production procedures into a single program. In addition, embodiments of the present invention can be implemented in conjunction with any hardware Boundary Scan platform such as platforms designed by Corelis, ASSET InterTech, JTAG Technologies, Gopel and the like.

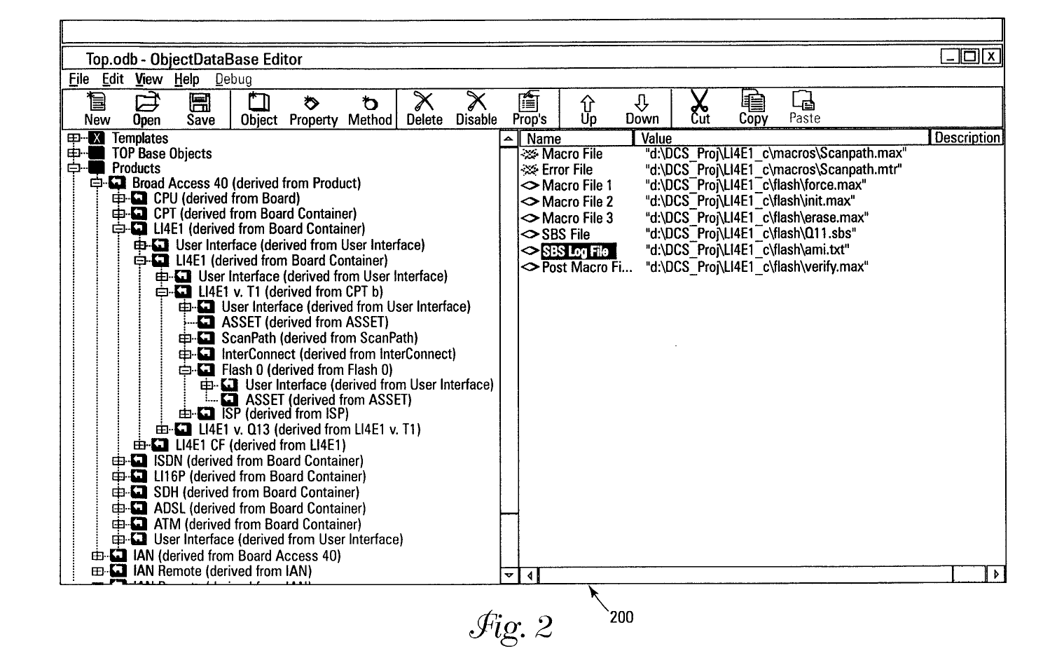

Embodiments of the present invention are based on a specifically designed database for use by volume board manufacturing facilities. In one embodiment, the database includes the complete information concerning a board's hardware (assembly) and firmware (on-board programming sequence). Embodiments of the database for the present invention represent a hierarchical structure of objects. Each object in the database represents a specific entity (a project, a board, a procedure, etc.) depending upon its type and position. An object has a number of properties that define object behavior. An object can be derived from another object, in which case a derived object inherits properties and child objects of its base object. A technician can modify the database via a database editor. The system includes a user-friendly editor interface for simple data management that is described with respect to FIG. 2, below.

Embodiments of the production procedures program are equipped with multiple service and information tools. In one embodiment, these tools include text information, statistics, and help for each production procedure. The procedures program integrates the production procedures into a single program capable of sequential execution for one or more products having one or more boards, board versions and firmware versions. The procedures program eliminates the need for individual test setups for each manufacturing stage of each board version or firmware version of each board and each product in production. As a result the program saves manufacturers money in equipment costs and provides one stop testing and programming during the manufacturing process. Embodiments of this invention are compatible with competitors' products and allow users to develop custom test programs to fit their needs and as a result provide the user with a great degree of flexibility.

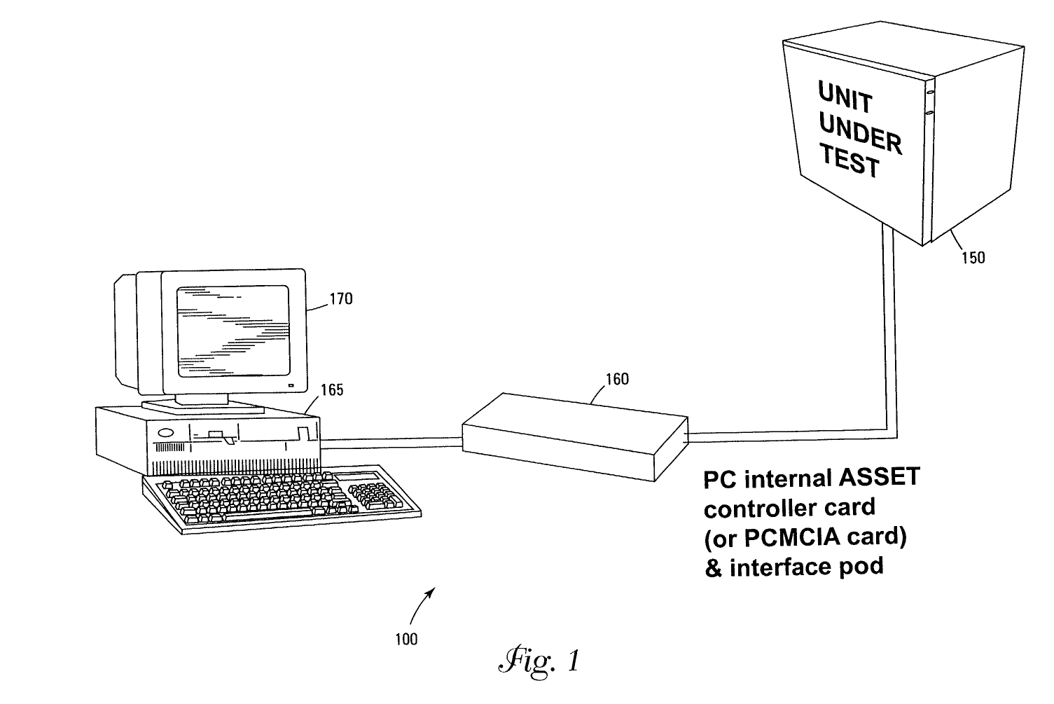

FIG. 1 is an illustration of one embodiment of a testing system, shown generally at 100, utilizing production procedures software according to the teachings of this invention. In operation, a unit under test 150 is coupled to a computer-processing unit 165 via a controller 160. In one embodiment, the unit under test 150 includes one or more electronic boards or a system employing one or more electronic boards. Computer-processing unit 165 is implemented with a production procedures software program according to the teachings of this invention.

In one embodiment, controller 160 is a JTAG compliant hardware controller. In one embodiment, controller 160 is a personal computer memory card international association (PCMCIA) card. In one embodiment controller 160 is internal to computer processing unit 165. Controller 160 provides the interface between the unit under test 150 and the computer-processing unit 165. Electronic boards of the unit under test 150 are also JTAG compliant.

Computer processing unit 165 includes a graphical user interface 170. The production procedures software program includes a database having information pertaining to the unit under test 150. The production procedures software program is interactive with an operator and provides a series of selection screens for the operator to select the product for evaluation and the procedures required.

FIG. 2 is an illustration of one embodiment of a database editor screen 200. Database editor screen 200 is intended for editing, inserting, deleting and all types of data processing related to testing and on-board programming of electronic boards. In one embodiment, using the editor screen 200, a user may change properties of each board such as which macro executive is run for specific steps or even change the user interface properties in the database. In one embodiment, the database is intended for use by a technician inserting and processing all data needs for sustaining all of the on-board test and processes. In one embodiment, standard object oriented programming is used and an object in the object database is defined as derived from another object. It inherits the base object properties in the child object.

In this example, on the left of editor screen 200 is the object hierarchy. Each cube on the screen is an object. For example the cube labeled “products” is an object and subtended from that object are the products included in the database of this embodiment. In this example, those products include Broad Access 40 (derived from products), IAN (derived from Broad Access 40), and IAN Remote (Derived from IAN). In one embodiment, each of the labeled products have objects subtended from them as required to support each product, boards used in that product, versions of those boards and firmware versions of those boards. On the right side of editor screen 200 the properties of the object that is currently selected are displayed.

To add a new board to the program, the database is edited to include the board and a new board will appear on the screen. In order to add the graphical information about a new board a technician specifies the paths of image files in specific property fields. These image files are board specific and can be created by digitally photographing or scanning the board. In one embodiment, the object database includes two programs, first is an object database editor that allows the user to create, view, and edit the databases and the second is a dynamic link library.

In one embodiment, in order to interface with macros, data, and images used by application programming tools of test product suppliers such as Corelis, JTAG Tech, Gopel and the like, the paths and names of macros, data, and images are saved in the database. Macros are executed via functions provided by a test product supplier such as Corelis, JTAG Tech, Gopel, or others that are Scan Function C, C++, or equivalent compatible. The production procedures software program retrieves macro, data, and image file names from the specific property fields of the database. These fields are editable by a technician.

Information in the database is input via a technician and includes information about each board under test e.g. macros, data files, image files. The format of each file is dependent upon the requirements of the specific application-programming tool. For example, in one embodiment the database includes information about one or more products each having one or more types of boards. In one embodiment, each of the types of boards is represented by one or more board versions. In one embodiment, each of the board versions is represented by one or more firmware versions. Information is provided in a hierarchical fashion starting with the systems, boards within each system, versions of each of those boards, and firmware versions of each of those boards. This type of hierarchical set up aids in the use of the system, as the information is easy to find and easily updated. For example if a technician maintaining this computer system wants to add a board a new object is created via the database editor. The new object can be derived from a base object that represents a board or from another existing board. The technician can edit the properties of a new object to include images, macros, and the like. To delete an existing board a technician would locate the specific object via the object editor delete the corresponding object from the database. The production procedures software is programmed for specific customer's boards being produced.

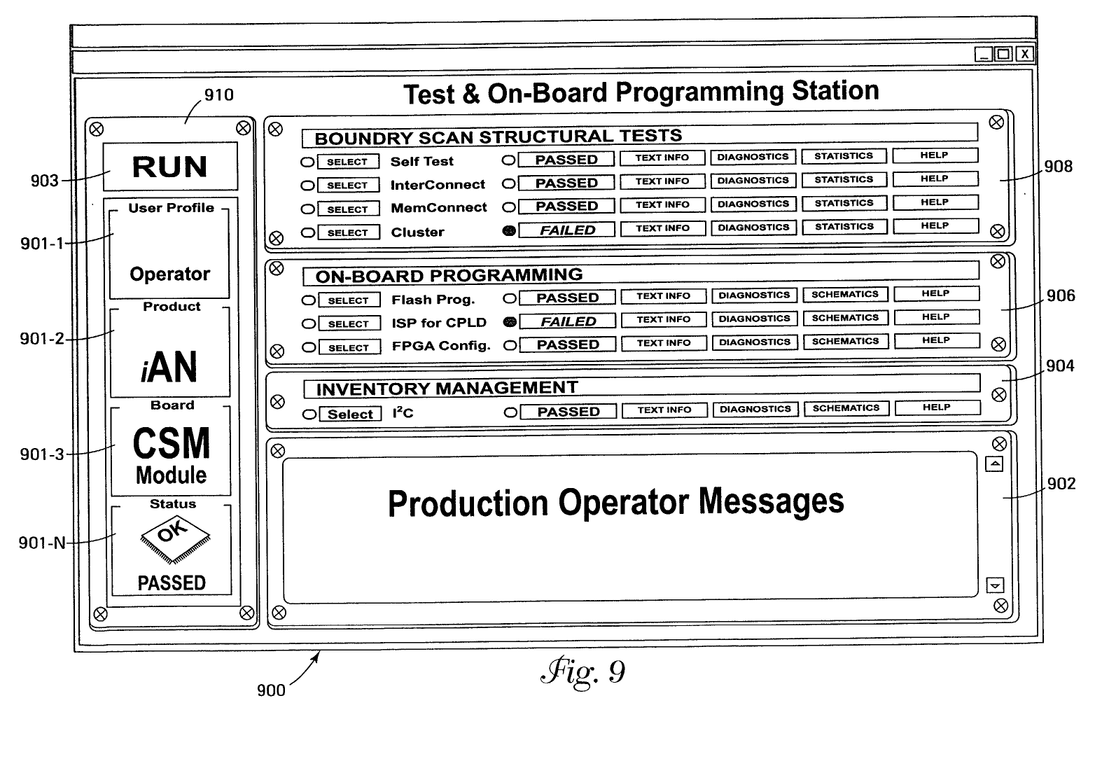

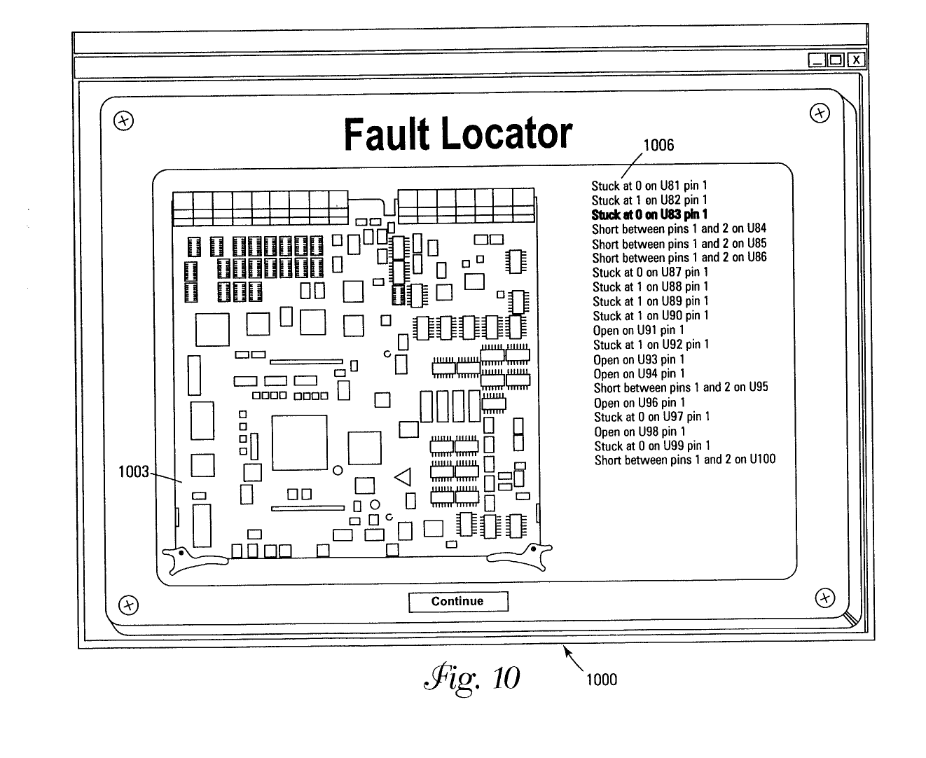

The first in a series of selection screens is a mode selection screen such as mode selection screen 300 shown in FIG. 3. Mode selection screen 300 includes at least two options, in this example the first option is automatic mode 302 and the second is manual mode 304. In one embodiment, when the automatic mode 302 is selected the operator can use a bar code reader coupled to the computer processing unit to enter the board part number or manually enter the board part number via a dialog screen. When the operator selects a mode a mode selection signal indicating the selected mode for operation is received and interpreted by the program. As a result, data is retrieved from the database. This data is based on the mode selected. When the automatic mode is selected the data retrieved includes a dialog screen in which the board part number can be entered. Once the part number is entered the program retrieves data from the database and displays an operator screen 900 as shown in FIG. 9. When the manual mode is selected the program looks in the database to determine which products are available. data retrieved includes the available products. The available products are displayed, e.g., graphically, as links that are selectable by a user. The program displays a product selection screen such as 400 with the available products as shown in FIG. 4.

In this example, product selection screen 400 displays two products that an operator can select from identified as 402-1 and 402-N in FIG. 4. When the operator selects the desired product for test via a pointer, mouse, etc. a product selection signal indicating the selected product is received and interpreted by the program. As a result, data is retrieved from the database. This data includes the available boards for this product. The program displays a board selection screen 500 as shown in FIG. 5.

In this example, board selection screen 500 displays boards 501-1 to 501-Z that are available for production procedures for the product selected. When the operator selects one of the boards 501-1 to 501-Z for test via a pointer, mouse, etc. a board selection signal indicating the selected board for test is received and interpreted by the program. As a result, data is retrieved from the database. This data includes the available board versions for this board. The program displays a board version selection screen 600 as shown in FIG. 6.

In this example, board version selection screen 600 displays board versions 604-1 to 604-R that are available based on the board selected. When the operator selects one of the board versions 604-1 to 604-R for test via a pointer, mouse, etc. a board version selection signal indicating the selected board version for test is received and interpreted by the program. As a result, data is retrieved from the database. This data includes the available firmware versions for this board version. The program displays a firmware version selection screen 700 as shown in FIG. 7.

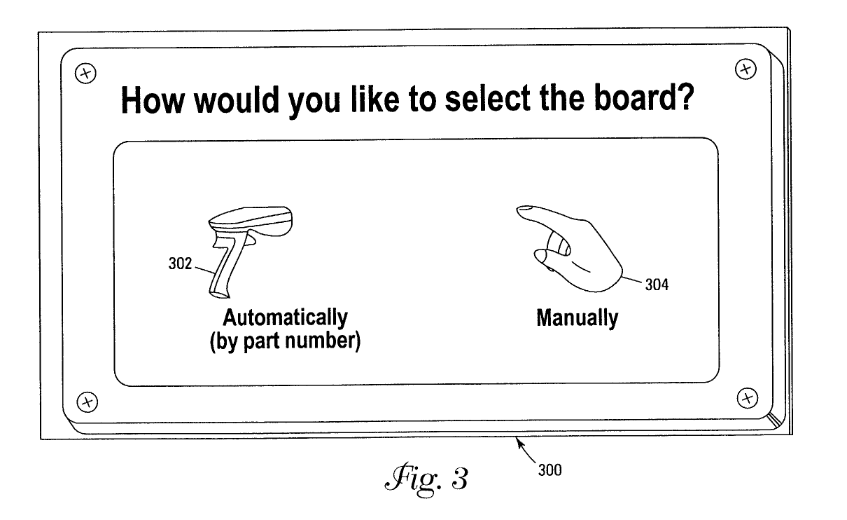

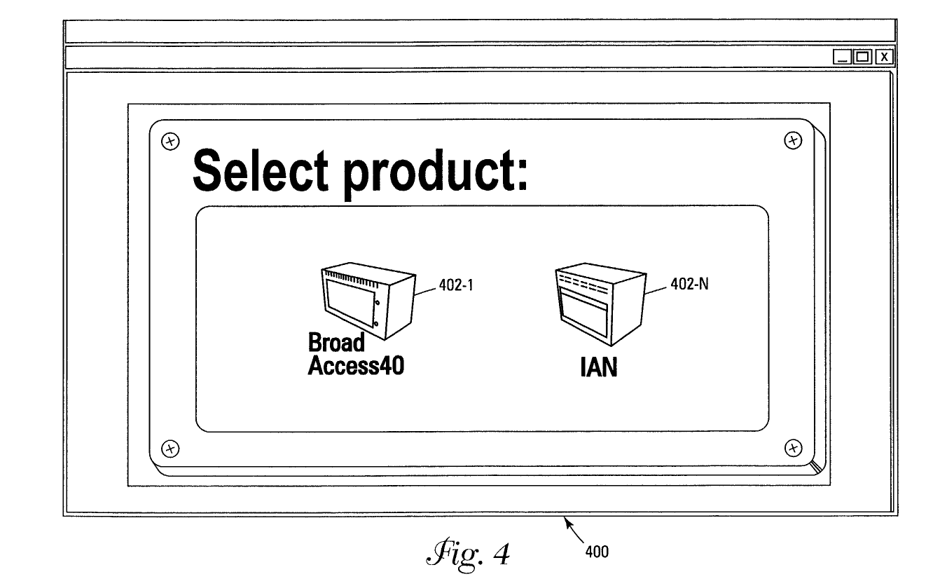

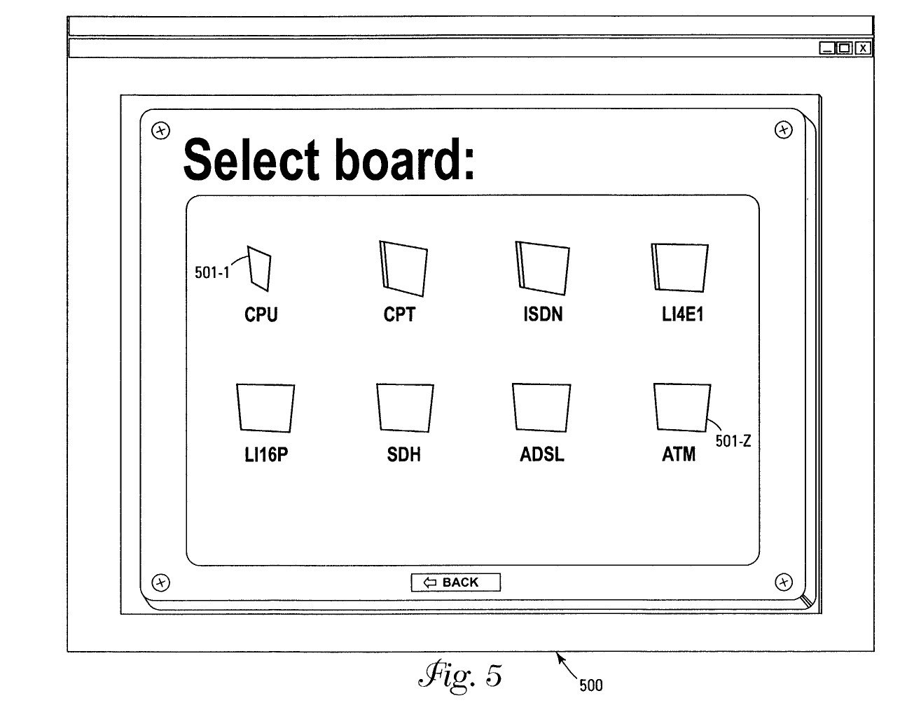

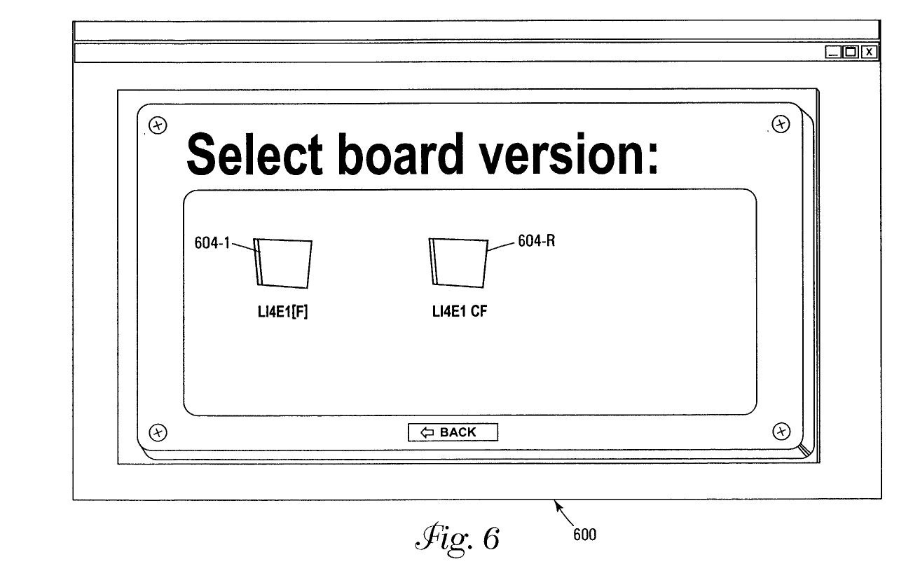

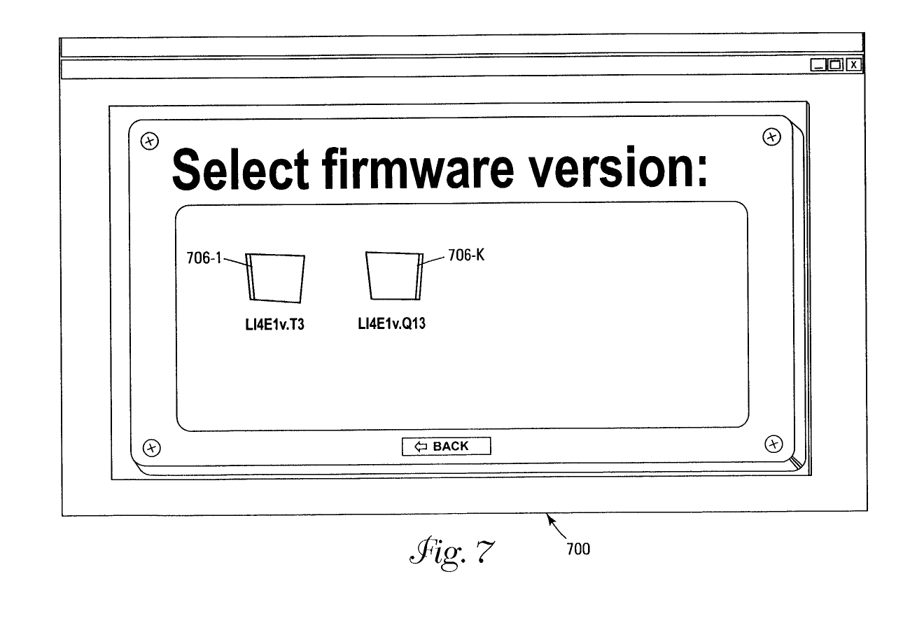

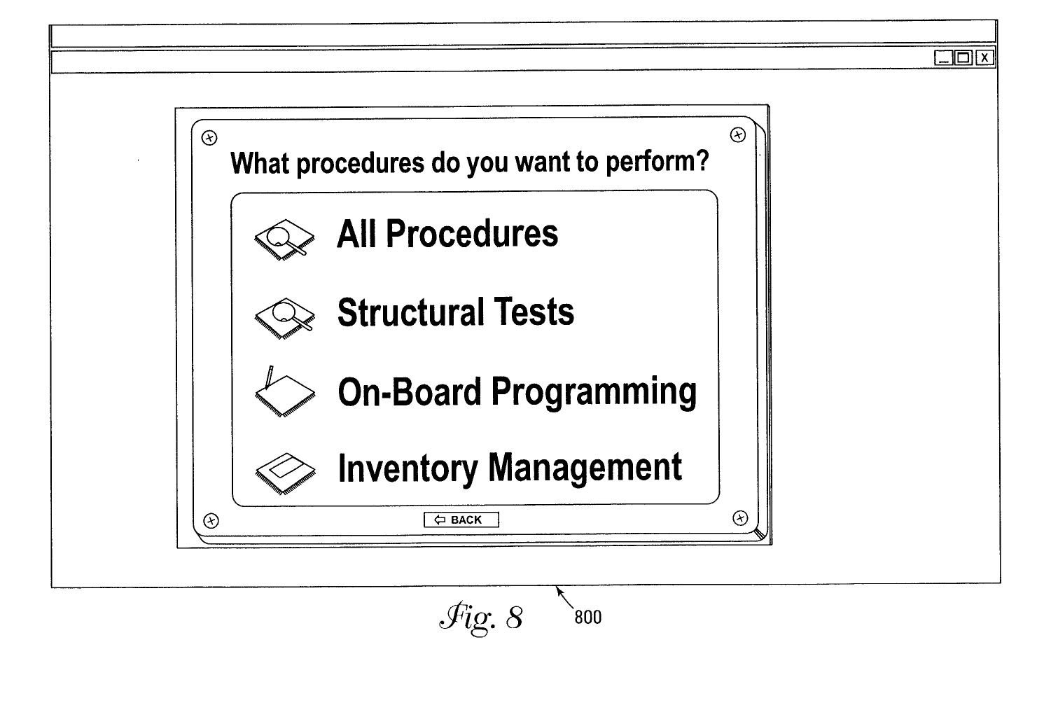

In this example, firmware version selection screen 700 displays firmware versions 706-1 to 706-K that are available based on the board version selected. When the operator selects one of the firmware versions 706-1 to 706-K for test via a pointer, mouse, etc. a firmware version selection signal indicating the selected firmware version of the selected board for test is received and interpreted by the program. As a result, data is retrieved from the database. This data includes the available production procedures for this product, board, board version and firmware version. The program displays a procedure selection screen 800 as shown in FIG. 8.

In this example four production procedures are available. These include all procedures, structural tests, on-board programming and inventory management programming. When an operator selects one or more of the production procedure options via a pointer, mouse, etc. a procedure selection signal indicating the procedure(s) selected is received and interpreted by the program. As a result, data is retrieved from the database. This data includes the operator, selected product, board, and status information. The program displays an operator screen 900 shown in FIG. 9.

FIG. 9 is an illustration of operator screen 900. Operator screen 900 is the graphical user interface that a user such as a production operator works with. In one embodiment, screen 900 includes a production operator message board 902 and a status screen 910. The production operator message board 902 provides messages in the process of running production procedures and provides an opportunity for the operator to output particular procedure scenarios. For example, in one embodiment, when the “text info” button is selected for a particular procedure and the procedure status is “passed” the following information would be visible on message board 902:

<procedure name>successfully completed

When the “text info” button is not selected for a particular procedure the following would be visible on message board 902:

running <procedure name>as sub-header;

<procedure name>successfully completed; or <procedure name>failed elapsed time <time>

When the “text info” button is selected a particular procedure and the board failed the procedure, the following would be visible on message board 902:

<procedure name>failed

possible failures: <list of failures

All of the above messages can be printed in the form of a test report that is appropriate for a particular user production facility.

Status screen 910 includes any number of display areas 901-1 to 901-N. In this embodiment, the display areas 901-1 to 901-N include a user profile area 901-1 that indicates who is using the system based on the appropriate data added in the database, a product identification area 901-2 that indicates the selected product based on a product selection signal, a circuit board identification area 901-3 that indicates the board under test based on one or more board, board version, and firmware version selection signals and a status area 901-N that indicates the status of the board under test based on results of the production procedures. In one embodiment, the status area 901-N indicates whether the board under test has passed or failed based on results of the production procedures. It is understood, that the status area 901-N can be designed to display any number of status indications based on the results of the production procedures. In one embodiment, the status area 901-N is programmed based on users' requirements. In addition, any of the display areas 901-1 to 901-N are programmable to display any status information required by a user.

Status screen 910 provides an area for quick review by an operator. In this embodiment, status screen 910 includes a run link 903 that enables the previously run procedures (or selected procedures) to be executed when run link 903 is selected. Once run link 903 is selected a run selection signal is received and the program executes desired production procedures of the item under test and displays the results in several locations on operator screen 900. The results of the production procedures are saved in memory of the computer processing unit. The interactive status screen 900 allows any number of production procedures to be executed.

Operator screen 900 includes a number of interactive areas 904, 906 and 908. Each interactive area 904, 906, and 908 provides the status of each of the individual procedures in a series of procedures. For example, in this embodiment interactive area 808 provides the status of the individual tests included in the series of boundary scan structural tests. The individual tests include self-test, interconnect test, memconnect test, and cluster test. Self-test is a test of the integrity of the board under test such as by using the Boundary Scan Chain, interconnect test detects and reports the faults such as different stuck-at conditions, bridging faults, opens and bad bi-directional boundary scan cells, memory connect test (memconnect) tests the interconnections to memory components that do not contain Boundary Scan implementation, cluster test is a test that uses Boundary Scan devices to apply test vectors to devices without Boundary Scan.

In this embodiment, interactive area 906 provides the status of the individual procedures included in the series of on-board programming that include flash programming, in-system programming (ISP) for CPLD and FPGA configuration. Additionally, interactive area 904 provides the status of the individual procedures included in the series of inventory management programming with serial I²C protocol. The inventory management is intended to store the inherent board information such as serial number, assembly version, firmware version and the like. In one embodiment, the production procedures software program produces reports that include statistics about boards tested and inventory management information.

Interactive areas 904, 906 and 908 provide a status indicator and a plurality of links to additional information for each individual procedure. In this embodiment, the status indicator is a pass or fail indicator. In this embodiment, interactive area 904 includes links to text information, diagnostics, statistics, and help which each lead to additional information about the specific test (i.e. self test, interconnect, memconnect, or cluster). Selecting a button representing the desired link activates the link. When a link is selected, the program receives a selection signal and information is retrieved (text info, diagnostics, statistics, help) with respect to the individual procedure or the series of procedures. Embodiments of the present invention produce reports based on this information that are printable.

Selecting “Text info” retrieves a description of the individual procedure, what each test or programming procedure means, and what test coverage is achieved for each test procedure for each board under test. When the “Statistics” link is selected for any one of the individual procedures, information about similar boards is provided, for example serial numbers that failed and their diagnostic information. This information is available for use by the production facility manager to obtain the “whole picture” with respect to each board, track trends, yield estimation and aid in identifying and alleviating future problems. When the “Help” link is selected for any one of the individual procedures the operator can gain access to an electrical schematic and diagrams for quick and efficient fault location. When the “Diagnostics” link is selected for any one of the individual procedures, a Fault Locator screen such as Fault Locator screen 1000 of FIG. 10 is displayed. When the “Schematics” link is selected for any one of the individual procedures a schematic of the board with the programming indicated is displayed. In addition, by selecting the link labeled “Select” for any of the individual procedures in a series of procedures, the individual procedure will be performed independent of the other procedures. It is understood, that all of the links that are mentioned above are easily modified to retrieve user specific information.

FIG. 10 is an illustration of one embodiment of a fault locator screen 1000 that is retrieved based on a “Diagnostics” link selection signal for a particular test within a series of tests. In this embodiment, the board under test 1003 is displayed on the left side of the screen 1000 and a list of test information 1006 to include defects is displayed on the right side of the screen 1000. This screen 1000 aids in performing diagnostics on a particular board.

Each of the boards under test meet two requirements:

1. The boards are be Boundary Scan (JTAG) compliant; and

2. The boards are designed according to design-for-testability (DFT) rules. The Boundary Scan compliance means that the board is populated with some (at least one) Boundary Scan devices that are connected in serial TDI-TDO chains with parallel TCK-TMS connections. The DFT rules compliance means that all key nets of the board are Boundary Scan controllable and/or observable.

Embodiments of the present invention require that the board under test be connectable to computer processing unit 165 via controller 160. For such connection the board requires the intended header or be connected via an edge connector. If the board level testability is implemented by the user, both the intended header or an edge connector are acceptable. The header or edge connector has to provide access to Boundary Scan standard signals (TDI, TDO, TMS, TCK). These four standard signals are the only required signals all additional signals are optional and user dependent.

In one embodiment, when the system level testability is implemented by a user, the edge connector only is in use. In such a case (in addition to the four standard signals mentioned above) some board address signals are user defined nets.

What is claimed is:

1. A production system for electronic circuits, the system comprising:
a computer having an associated storage medium;
an interface unit, coupled to the computer, and providing at least one port that is adapted to be coupled to the electronic circuit; and
an editable object database, stored on the storage medium, the object database including information on system parameters selectively used by the computer and the interface unit to implement a plurality of production procedures for the electronic circuit.

2. The system of claim 1, wherein the interface unit is JTAG compliant.

3. The system of claim 1, wherein the electronic circuit is JTAG compliant.

4. The system of claim 1, wherein the interface unit is a personal computer memory card international association card.

5. The system of claim 1, wherein the editable object database includes a set of computer executable instructions for implementing the plurality of production procedures.

6. The system of claim 1, wherein the production procedures include boundary scan structural testing procedures.

7. The system of claim 1, wherein the production procedures include on-board programming procedures.

8. The system of claim 6, wherein the boundary scan structural testing procedures include self-test, interconnect, memconnect and cluster testing.

9. The system of claim 7, wherein the on-board programming procedures include flash on board programming, in system programming for computer programmable logic devices and field programmable gate array on board programming.

10. The system of claim 1, wherein the production procedures include inventory management programming.

11. A production system for electronic circuits, the system comprising:
a computer having an associated storage medium;
an interface unit, coupled to the computer, and providing at least one port that is adapted to be coupled to an electronic circuit;
an editable object database, stored on the storage medium, the object database including information on system parameters selectively used by the computer and the interface unit to implement a plurality of production procedures for the electronic circuit; and
a graphical user interface, that runs on the computer, the interface providing a plurality of selection screens to define the production procedures in a hierarchical flow beginning with selection of the product based on information in the object database.

12. The system of claim 11, wherein the interface unit is JTAG compliant.

13. The system of claim 11, wherein the electronic circuit is JTAG compliant.

14. The system of claim 11, wherein the interface unit is a PCMCIA card.

15. The system of claim 11, wherein the production procedures include boundary scan structural testing procedures.

16. The system of claim 11, wherein the production procedures include on-board programming procedures.

17. The system of claim 15, wherein the boundary scan structural testing procedures include self-test, interconnect, memconnect and cluster testing.

18. The system of claim 16, wherein the on-board programming procedures include flash on board programming, in system programming for computer programmable logic devices and field programmable gate array on board programming.

19. The system of claim 11, wherein the production procedures include inventory management programming.

20. A method for configuring production procedures for an electronic circuit, the method comprising:
providing a selection mechanism to identify the type of the electronic circuit;
retrieving a plurality of module types for the selected electronic circuit;
providing a selection mechanism to identify the module type;
retrieving additional selection options for the electronic circuit based on the module type; and
presenting selection mechanisms in a hierarchical manner for the additional selection options.

21. The method of claim 20, wherein retrieving additional selection options for the electronic circuit comprises retrieving board and firmware version selection options for the electronic circuit.

22. The method of claim 20, further comprising providing a selection mechanism to identify production procedures for the electronic circuit; and
executing the production procedures based on selected production procedures.

23. The method of claim 22, wherein providing a selection mechanism to identify production procedures for the electronic circuit comprises providing a selection mechanism to identify production procedures electronic circuit, wherein the production procedures include boundary scan structural tests and on-board programming.

24. The method of claim 23, wherein the production procedures further include inventory management.

25. A method for configuring production procedures for an electronic circuit, the method comprising:
providing a selection mechanism to identify the type of the electronic circuit;
retrieving a plurality of versions for the selected electronic circuit;
providing a selection mechanism to identify the plurality of versions;
retrieving additional selection options for the electronic circuit based on the plurality of versions;
presenting selection mechanisms in a hierarchical manner for the additional selection options; and
executing a sequential series of production procedures on the electronic circuit.

26. The method of claim 25, wherein executing a sequential series of production procedures on the electronic circuit comprises executing a sequential series of production procedures on the electronic circuit, wherein the production procedures include boundary scan structural tests.

27. The method of claim 26, wherein the boundary scan structural tests include one or more of self-test, interconnect test, memconnect test and cluster test.

28. The method of claim 25, wherein executing a sequential series of production procedures on the electronic circuit comprises executing a sequential series of production procedures on the electronic circuit, wherein the production procedures include on-board programming.

29. The method of claim 28, wherein the on-board programming includes one or more of flash programming, in-system programming for complex programmable logic devices, field programmable gate array configuration and inventory management programming.

30. The method of claim 25, further comprising presenting a status of each of the procedures of the series of production procedures via an interactive operator screen.

31. The method of claim 30, further comprising providing information about one or more procedures via an operator message board.

32. The method of claim 30, further comprising providing one or more links for each production procedure, wherein when a link is selected information is retrieved about a specific procedure.

33. The method of claim 32, wherein providing one or more links for each production procedure comprises providing one or more links for each production procedure, wherein when a link is selected information is retrieved about a specific procedure and wherein the one or more links include text information, diagnostics, statistics, help, and schematics.

34. The method of claim 25, wherein retrieving a plurality of versions for the selected electronic circuit comprises retrieving a plurality of hardware versions for the selected electronic circuit.

35. The method of claim 25, wherein retrieving a plurality of versions for the selected electronic circuit comprises retrieving a plurality of firmware versions for the selected electronic circuit.
